(19) United States
(12) Patent Application Publication
(10) Pub. No.: US 2023/0060093 A1
(43) Pub. Date: Feb. 23, 2023

(54) HIGH-FLUX WATER PERMEABLE MEMBRANES

(71) Applicant: Ohio State Innovation Foundation, Columbus, OH (US)

(72) Inventor: W.S. Winston HO, Columbus, OH (US)

(21) Appl. No.: 17/789,438

(22) PCT Filed: Dec. 28, 2020
(86) PCT No.: PCT/US2020/067129

§ 371 Date: Jun. 27, 2022

Related U.S. Application Data
(60) Provisional application No. 62/954,217, filed on Dec. 27, 2019.

(51) Int. Cl. B01D 71/56; B01D 61/02; B01D 67/00; B01D 69/14; B01D 69/12; C02F 1/44

(52) U.S. Cl. CPC B01D 71/56; B01D 61/025; B01D 67/0006; B01D 69/148; B01D 69/1251; C02F 1/441; B01D 2323/30; B01D 2325/12; B01D 2325/36; B01D 2323/02; B01D 2323/12; C02F 2103/08

(57) ABSTRACT

Water permeable membranes and methods of preparation are described. The water permeable membrane can comprise a porous support, and a polyamide layer comprising a crosslinked polyamide on a surface of the porous support, wherein the polyamide layer further comprises nanoparticles and a hydrophilic additive, and wherein the hydrophilic additive covalently bonds to the crosslinked polyamide. The crosslinked polyamide can be interfacially polymerized on the porous support. Methods for desalinating water, performing dialysis, or performing pervaporation using the water permeable membranes are disclosed.

### CROSS-REFERENCE TO RELATED APPLICATIONS

This application claims benefit of U.S. Provisional Application No. 62/954,217, filed Dec. 27, 2019, which is hereby incorporated by reference in its entirety

### FIELD

This disclosure relates generally to water permeable membranes and methods of forming water permeable membranes.

### BACKGROUND

Water permeable membranes may be used in a number of applications to provide desired separation of components. For example, dissolved substances such as salts can be separated from their solvents, e.g., water, by a procedure known as reverse osmosis. Reverse osmosis is an effective and versatile technology for water desalination. This technology can produce potable water from brackish and sea waters as well as surface, lake, and river waters in a one-step process after feed pretreatment. Thus, large volumes of usable water for industrial, agricultural, and home use can be produced from previously unusable water sources. In another example, water permeable membranes may be useful in dialysis and pervaporation.

Water permeable membranes have been described. However, although these water permeable membranes may have good performance including high salt rejection and good water flux, increased water flux, high salt rejection, or both are desirable.

The compositions and methods described herein address these and other needs.

### SUMMARY

Water permeable membranes and methods of preparation are described herein. In some aspects, the water permeable membrane can comprise a porous support, and a polyamide layer comprising a crosslinked polyamide on a surface of the porous support, wherein the polyamide layer further comprises nanoparticles and a hydrophilic additive, and wherein the hydrophilic additive covalently bonds to the crosslinked polyamide. The crosslinked polyamide can be interfacially polymerized on the porous support.

In some embodiments, the crosslinked polyamide can be derived from a polyamine monomer and a polyfunctional acyl halide. The polyamine monomer may include an aromatic group or an aromatic-aliphatic group.

The nanoparticles in the polyamide layer can be selected from zeolite Y nanoparticles, fumed silica nanoparticles, alumina nanoparticles, titanic nanoparticles, zirconia. nanoparticles, clay nanoparticles, carbon nanoparticles, metal-organic framework (MOF) nanoparticles, zeolitic imidazole framework (ZIF) nanoparticles, or combinations thereof. The nanoparticles and the crosslinked polyamide can be present in a weight ratio of from 0.01:500 to 0.2:1, or from 0.01:100 to 0.1:1, from 0.01:500 to 0.01:1, or from 0.01:100 to 0.01:1.

The hydrophilic additive generally includes a reactive group for reaction with the crosslinked polyamide. In some embodiments, the hydrophilic additive can be derived from a compound selected from 4-(2-hydroxyethyl) morpholine, 2-(2-hydroxyethyl) pyridine, o-aminobenzoic acid-triethylamine, m-aminohenzoic acid-triethylamine, p-aminobenzoic acid-triethylamine, o-aminobenzenesulfonic acid-triethylamine, m-aminobenzenesulfonic acid-triethylamine, p-ami nobenezenesulfonic acid-triethylamine, o-aminotoluenesulfonic acid-triethylamine, m-aminotoluenesulfonic acid-triethylamine, p-aminotoluenesulfonic acid-triethylamine, o-hydroxybenzoic acid-triethylamine, m-hydroxybenzoic acid-triethylamine, p-hydroxybenzoic acid-triethylamine, a salt thereof, or a combination thereof. In certain embodiments, the hydrophilic additive can be derived from:

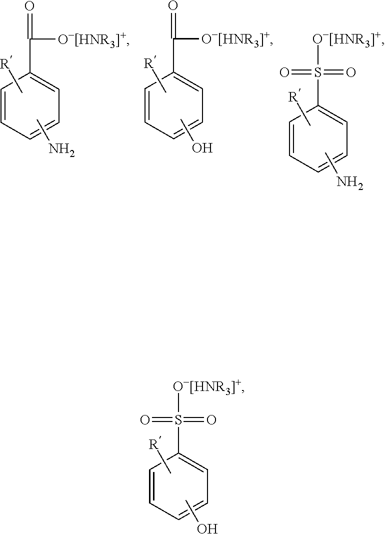

or a combination thereof, wherein each occurrence of R is independently selected from a substituted or unsubstituted C₁-C₉ alkyl, a substituted or unsubstituted C₂-C₉ alkenyl, or a substituted or unsubstituted C₂-C₉ alkynyl; and R′ is absent or selected from substituted or unsubstituted C₁-C₉ alkyl, a substituted or unsubstituted C₂-C₉ alkenyl, or a substituted or unsubstituted C₂-C₉ alkynyl. Preferably, the hydrophilic additive is included in the polyamide layer during interfacial polymerization of the crosslinked polyamide. Further examples of hydrophilic additives that can be included in the water permeable membrane can be selected from

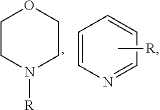

or a salt thereof, or a combination thereof; wherein R is selected from a saturated, unsaturated, substituted, or unsubstituted C₁-C₉ alcohol, or a saturated, unsaturated, substituted, or unsubstituted C₁-C₉ amine. The hydrophilic additive and the crosslinked polyamide can be present in a weight ratio of from 0.1:100 to 05:1, or from 0.5:50 to 0.2:1, from 0.1:100 to 0.1:1, or from 0.5:50 to 0.5:1.

The water permeable membrane, comprising a sufficient amount of hydrophilic additive and/or nanoparticles, can exhibit a salt rejection capability of at least 98%, when measured at with a 2000 ppm NaCl solution at 225 psi and a flux rate of at least 34 gfd.

In some examples, the water permeable membrane can comprise a porous support, and a polyamide layer comprising a crosslinked polyamide interfacially polymerized on a surface of the porous support, wherein the polyamide layer further comprises a hydrophilic additive and nanoparticles selected from the group consisting of zeolite Y, fumed silica, alumina, titania, zirconia, clay, carbon, metal-organic framework (MOF), zeolitic imidazole framework (ZIF), and a combination thereof. In these examples, the hydrophilic additive can covalently bond to the crosslinked polyamide.

In other examples, the water permeable membrane can comprise a porous support, and a polyamide layer comprising a crosslinked polyamide interfacially polymerized on a surface of the porous support, wherein the polyamide layer further comprises nanoparticles and a hydrophilic additive derived from a hydrophilic, reactive additive selected from:

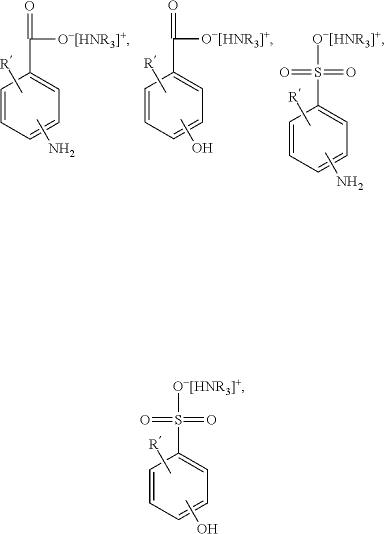

or a combination thereof, wherein each occurrence of R is independently selected from a substituted or unsubstituted C₁-C₉ alkyl, a substituted or unsubstituted C₂-C₉ alkenyl, or a substituted or unsubstituted C₂-C₉ alkynyl, and is absent or selected from substituted or unsubstituted C₁-C₉ alkyl, a substituted or unsubstituted C₂-C₉ alkenyl, or a substituted or unsubstituted C₂-C₉ alkynyl.

In further examples, the water permeable membrane can comprise nanoparticles; a crosslinked polyamide disposed on a surface of a porous substrate, wherein the crosslinked polyamide is formed by interfacially polymerizing a multifunctional amine with a multifunctional acyl halide in an amount, such that at least a portion of amine functional groups, acyl halide functional groups, or combinations thereof remain unreacted and form pendent reactive groups on the crosslinked polyamide; and a hydrophilic additive selected from:

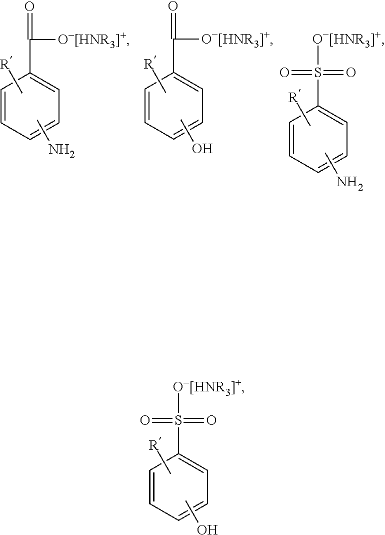

or a combination thereof, wherein each occurrence of R is independently selected from a substituted or unsubstituted C₁-C₉ alkyl, a substituted or unsubstituted C₂-C₉ alkenyl, or a substituted or unsubstituted C₂-C₉ alkynyl; and R′ is absent or selected from substituted or unsubstituted C₁-C₉ alkyl, a substituted or unsubstituted C₂-C₉ alkenyl, or a substituted or unsubstituted C₂-C₉ alkynyl; wherein the hydrophilic additive reacts with the pendant reactive group to covalently bind the hydrophilic additive and the crosslinked polyamide, and wherein the membrane exhibits improved water flux and improved salt retention properties compared to an otherwise identical membrane that does not contain the hydrophilic additive.

Methods for forming the water permeable membrane are also disclosed. The methods can include applying a polyamine solution comprising a polyamine monomer to a porous support; applying an acyl halide solution comprising a polyfunctional acyl halide to the porous support; and allowing the polyamine monomer and the polyfunctional acyl halide to polymerize on a pore surface of the porous support to form a crosslinked polyamide, wherein nanoparticles and a hydrophilic reactive additive are independently present in at least one of the polyamine solution or the acyl halide solution. As described herein, the crosslinked polyamide can be interfacially polymerized on the porous support. some embodiments, the polyamine solution can comprise from 0.05 to 1%, or 0.1 to 0.5%, by weight of nanoparticles. In some embodiments, the polyamine solution can comprise from 0.2 to 20%, or 1 to 10%, or from 0.05 to 1%, or 2 to 4%, by weight of the hydrophilic additive, The method of forming the membranes can further comprise soaking the water permeable membrane in a flux enhancing solution.

Methods for desalinating water comprising passing the water under pressure through a membrane disclosed herein are described.

Methods for performing dialysis comprising contacting a. membrane disclosed herein with a solution containing solutes and allowing water to diffuse through the membrane are also described.

Methods for performing pervaporation comprising contacting a membrane disclosed herein with a teed solution and allowing pervaporation to occur under vacuum on the permeate side, are further described.

### DETAILED DESCRIPTION

The present disclosure will now be described with occasional reference to the specific embodiments of the disclosure. This disclosure may, however, be embodied in different forms and should not be construed as limited to the embodiments set forth herein. Rather, these embodiments are provided so that this disclosure will be thorough and complete.

Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure. As used in the description of the disclosure and the appended claims, the singular forms “a,” “an,” and “the” are intended to include the plural forms as well, unless the context dearly indicates otherwise. All publications, patent applications, patents, and other references mentioned herein are incorporated by reference in their entirety.

Unless otherwise indicated, all numbers expressing quantities of ingredients, properties such as molecular weight, reaction conditions, and so forth as used in the specification and claims are to be understood as being modified in all instances by the term “.” Accordingly, unless otherwise indicated, the numerical properties set forth in the following specification and claims are approximations that may vary depending on the desired properties sought to be obtained in embodiments of the present disclosure. Notwithstanding that the numerical ranges and parameters setting forth the broad scope of the disclosure are approximations, the numerical values set forth in the specific examples are reported as precisely as possible. Any numerical values, however, inherently contain certain errors necessarily resulting from error found in their respective measurements.

In accordance with embodiments of this disclosure, water permeable membranes having at least one kind of nanoparticles and an additive derived from a hydrophilic, reactive compound are provided. Furthermore, in accordance with other embodiments of this disclosure, methods of forming water permeable membranes having at least one kind of nanoparticles and an additive derived from a hydrophilic, reactive compound are provided. The water permeable membranes may comprise a membrane formed from a crosslinked polyamide interfacially polymerized on a porous support. In some examples, the membranes exhibit improved salt rejection capability, improved flux rates, or both. The membranes and methods of forming the membranes are discussed with further specificity below.

Interfacial Polymerization of the Polyamide

As described herein, the membranes comprise a crosslinked polyamide. In some embodiments, the membranes comprise a crosslinked aromatic polyamide. The crosslinked polyamide can be formed by interfacially polymerizing the polyamide on a porous support. For example, interfacial polymerization may be performed by contacting a suitable porous support with a solution of a polyamine monomer (such as an aromatic polyamine or aromatic/aliphatic polyamine) in a suitable solvent and then contacting the polyamine-wetted porous support with a polyfunctional acyl halide also in a suitable solvent, whereby the polyamine monomer and the polyfunctional acyl halide polymerize interfacially. It will be understood that the term “interfacial polymerization” refers to the polymerization or crosslinking of, for example, the polyamine monomer and the polyfunctional acyl halide, on the pore surfaces of the porous support.

In some examples, the polyamine monomer to be used may be any essentially monomeric amine having at least, two amine functional groups, such as two to ten, two to six, two to four, or two to three, or more amine functional groups. The particular polyamine employed is not critical, and any suitable polyamine monomer now or hereafter known to be useful for making membranes (such as membranes based on crosslinked aromatic or aromatic/aliphatic polyamides interfacially polymerized on a porous support) can be used for this purpose. Examples of suitable polyamine monomers can include, but are not limited to, m-phenylenediamine, o-phenylenediamine, p-phenylenediamine, piperazine, 1,3,5-triaminobenzene, 4,4′-oxydianiline, 3,4′-oxydianiline, 4,4′-methylene dianiline, 4,4′-methylene di-o-chloroaniline, polyethyleneimine, and polyallylamine. Mixtures of polyamine monomers can also be used.

In some examples, before contacting with the porous support, the polyamine can be dissolved in a suitable solvent, Examples of suitable solvents include, but are not limited to, water, isopropyl alcohol, ethanol, methanol, butanol, pentanol, hexanol, heptanal, octanol, nonanol, decanol, undecanol, and decanol, and mixtures thereof. It will be understood that any suitable concentration of polyamine monomer may be used. For example, the concentration of the polyamine monomer in solution can be 0.1 to 30.0% by weight, 0.1 to 20.0% by weight, 0.1 to 10.0% by weight, 1.0 to 8.0% by weight, or 1.5 to 2.5% by weight.

In some examples, any suitable polyfunctional acyl halides can be used to form the membranes of the present disclosure. These compounds may be essentially monomeric, aromatic or aromaticlaliphatic amine-reactive polyfunctional acyl halides, having at least two, such as two to ten, two to six, two to four, or two to three, or more acyl halide groups per molecule. In some examples, chlorides may be particularly desirable due to lower cost and greater availability in comparison to the corresponding bromides or iodides. Examples of suitable acyl halides include, but are not limited to, trimesoyl chloride, isophthaloyl chloride, terephthaloyl chloride, cyclohexane-1,3,5-tricarbonyl chloride, 1-isocyanato-3,5-benzenedicarbonyl chloride (5-isocyanato-isophthaloyl chloride), ada.mantane-2,6-dione-1,3,5,7-tetracarbonyl chloride, or mixtures thereof.

In some instances, before contacting with the porous support, the acyl halide may be dissolved in a suitable organic solvent in accordance with known methods. For example, non-polar organic solvents which are capable of dissolving the polyfunctional acyl halide being used and which are also immiscible with water may be used. Examples of suitable solvents include, but are not limited to, cyclohexane, heptane, and alkalies having from 6 to 12 carbon atoms. In some examples, ISOPAR® G, which is a mixture of alkanes having 8 to 12 carbon atoms, may be used, It will be understood that any suitable concentration of acyl halide may be used. For example, the acyl halide may be present in solution in an amount of 0.005 to 30.0% by weight, 0.005 to 20.0% by weight, 0.005 to 10.0% by weight, 0.005 to 5.0% by weight, 0.01 to 0.5% by weight, or 0.05 to 0.1% by weight. U.S. Pat. No. 4,277,344 contains examples of suitable systems and methods that may be employed in forming the crosslinked polyamide, which are incorporated herein by reference,

It will be understood that any suitable technique may be used to form the membrane, for example, comprising an aromatic or aromatic/aliphatic polyamide interfacially polymerized on a porous support. For example, rather than applying the polyamine first and thereafter applying the polyfunctional acyl halide second, these steps can be reversed by contacting the porous support with a solution of the polyfunctional acyl halide first and then contacting the acyl halide-wetted porous support with the polyamine second.

In other examples, other polyamide producing chemical reactions can be used in place of the amine/acyl halide reaction described above. For example, dicarboxylic acids and diamines could be condensation polymerized on the porous support by contacting the porous support with a solution of a dicarboxylic acid in a suitable solvent and then contacting the dicarboxylic acid-wetted porous support with a diamine also in a suitable solvent. Alternatively, the porous support can be contacted with the diamine first followed by the dicarboxylic acid second. Also, instead of using an aromatic dicarboxylic acid, an aromatic diamine can be used for introducing the aromatic groups. Thus, it will be understood that any suitable technique which is now or hereafter known to produce a membrane, for example, comprising an aromatic or aromatic/aliphatic polyamide interfacially polymerized on a porous support can be used to form the membrane of the present disclosure.

Porous Support

Any suitable porous support may be used to form the water permeable membranes of the present disclosure. For example, the porous support may be formed from a synthetic polymerized material such as polysulfone, polyarylether sulfone, polyimide, polystyrene, or various halogenated polymers such as polyvinylidene fluoride. In some examples, the porous support comprises polysulfone.

It will be understood that a porous support having any suitable pore size may be used. For example, the pores may be sufficiently small enough to allow bridging-over the pores during polymerization, but not so small as to hinder passage of permeate. In other examples, the pores may have diameters in the micrometer or nanometer range. For example, the pores may have diameters of 1 nm or greater, 5 nm or greater, 10 nm or greater, such as 1 to 1000 nm, 1 to 500 nm, 1 to 250 nm, 5 to 250 nm, 5 to 100 nm, 5 to 80 nm, 5 to 50 nm, 10 to 250 nm, 10 to 100 nm, 10 to 80 nm, 10 to 50 nm, 20 to 250 nm, 20 to 100 nm, 20 to 80 nm, or 20 to 50 nm.

Nanopartides

Nanoparticles can be used as flux-enhancing additives in the membranes. The nanoparticles can be hydrophilic nanoparticles, hydrophobic nanoparticles, combinations of two or more hydrophilic nanoparticles, combinations of two or more hydrophobic nanoparticles, or combinations of hydrophilic and hydrophobic nanoparticles. Suitable examples of hydrophilic nanoparticles include, but are not limited to, zeolite Y, fumed silica, alumina, titania, zirconia, clay, or mixtures thereof. Suitable examples of hydrophobic nanoparticles include, but are not limited to, carbon nanoparticles, metal-organic frameworks (MOFs), zeolitic imidazole frameworks (ZIFs), or mixtures thereof. The nanoparticles may have an average particle size of 1 nm or greater, 5 nm or greater, 10 nm or greater, such as from 1 nm to 300 nm, from 1 nm to 100 nm, from 2 nm to 300 nm, from 2 nm to 100 nm, from 3 nm to 200 um, from 5 nm to 100 nm, or from 10 nm to 50 nm.

The specific concentration or amount of nanoparticles used may vary, depending on the particular polyamide being made and the particular kind of nanoparticles being used. In some examples, the nanoparticles and the crosslinked polyamide can be present in a weight ratio of 0.01:500 or greater, such as 0.01:400 or greater, 0.01:300 or greater, 0.01:100 or greater, 0.01:50 or greater, 0.01:20 or greater, 0.01:10 or greater, from 0.01:500 to 0.2:1, or from 0.01:100 to 0.1:1.

In some examples, the nanoparticles can be included in the solution comprising the polyamine or the acyl halide, before contacting the porous support. The concentration of the nanoparticles in the polyamine solution of polyfunctional acyl halide solution can be from 0.01 to 10.0% by weight, from 0.05 to 5.0% by weight, from 0.08 to 2.0% by weight, or from 0.1 to 0.5% by weight.

Hydrophilic and Reactive Additives

In accordance with embodiments of this disclosure, it has been found that the water flux capacity, salt rejection capabilities, or both of water permeable membranes formed in accordance with the methods of the present disclosure may be enhanced by the addition of at least one hydrophilic additive to the polyamide. Thus, in accordance with embodiments of the present disclosure, water permeable membranes comprising a membrane formed from a crosslinked polyamide, such as a crosslinked aromatic or aromatic/aliphatic polyamide interfacially polymerized on a porous support and further having at least one kind of nanoparticles and one hydrophilic additive derived from a hydrophilic, reactive additive are provided.

The hydrophilic, reactive additive is selected to have a reactive portion that reacts with at least one of the components that reacts to form the polyamide. For example, the reactive portion may be selected to react with one or both of the polyamine and the polyfunctional acyl halide during the interfacial polymerization reaction, when the polyamine and polyfunctional acyl halide are used. The hydrophilic, reactive additive also has a hydrophilic portion. It is believed that the hydrophilic portion can provide passage for hydrophilic permeates, such as water, through the membrane. Thus, the hydrophilic, reactive additive is an additive having bifunctionality. According to various embodiments, the hydrophilic additive derived from the hydrophilic, reactive additive may provide interruptions in the polyamide chain to facilitate passage of water or other permeates through the membrane.

In some embodiments, the hydrophilic additive may be chemically bonded to the polyamide. In this context, “chemically bonded” means that the hydrophilic additive is not merely physically present in the polyamide. Rather, “chemically bonded” indicates that some form of chemical bond such as a covalent bond or an ionic bond is formed between the hydrophilic compound and the polyamide.

The hydrophilic additive may be incorporated into the membrane in any suitable manner. For example, the polyamide may be formed from a polyamine and polyfunctional acyl halide, as discussed above, and at least one hydrophilic, reactive additive may be included in the reaction system. The hydrophilic, reactive additive may have a reactive portion that includes a moiety capable of reacting with either (or both) of the polyamine or the polyfunctional acyl halide during the interfacial polymerization reaction.

For example, one approach is to include in the polyamine solution a hydrophilic additive containing an acyl halide-reactive moiety so that the hydrophilic, reactive additive reacts with and is chemically bonded to the polyfunctional acyl halide in the subsequently formed polyamide. Another approach is to include in the polyfunctional acyl halide solution a reactive additive that reacts with and is chemically bonded to the polyamine of the subsequently formed polyamide. Still another approach for forming the water permeable membranes is to incorporate the hydrophilic, reactive additive or additives into the system after the interfacially formed polyamide is made. The additive or additives may be incorporated in any suitable manner. For example, the hydrophilic, reactive additive may be incorporated by forming the polyamide in such a way that it includes pendant reactive groups and then contacting the polyamide so formed with a hydrophilic, reactive additive capable of reacting with the pendant groups. For example, a polyamide made with an excess of polyfunctional amine such that the product polymer includes pendant amino groups could be subsequently reacted with a hydrophilic, reactive additive that is amine reactive.

Any suitable reactive portion may be present in the compound. For example, reactive portions may include amino and hydroxyl groups. Any suitable hydrophilic portion may be present in the compound. For example, hydrophilic portions may include compounds that contain, and/or can yield in aqueous solution, one or more of the following hydrophilic groups: a carboxyl group, a C₁-C₉ alkyl amine salt of a carboxyl group, a sulfonyl group, a C₁-C₉ alkyl amine salt of a sulfonyl group, a hydroxyl group, a morpholine group, a pyridine group, or combinations thereof.

In some embodiments, the hydrophilic, reactive additive may have a structure as shown below:

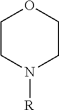

or a salt thereof, wherein R is a C₁-C₉ saturated or unsaturated, substituted or unsubstituted, straight or branched alcohol or a C₁-C₉ saturated or unsaturated, substituted or unsubstituted, straight or branched amine. For example, R is selected from a saturated or unsaturated, substituted or unsubstituted C₁-C₉ alcohol, or a saturated or unsaturated, substituted or unsubstituted C₁-C₉ amine. In this example of the hydrophilic, reactive additive, the morpholine portion of the additive is the hydrophilic portion and the amine or alcohol is the reactive portion. It will be understood that any suitable salt may be used. For example, the salt may be derived from one of the acids, wherein the cation of the salt is selected from lithium, sodium, potassium, Groups IIA, IB, IIB III, , and VIII metals, ammonium, C₂-C₁₂ alkyl ammonium, quaternary ammonium, and C₁₂-C₂₄ alkyl quaternary ammonium.

In some embodiments, the hydrophilic, reactive additive may have a structure as shown below:

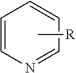

or a salt thereof, wherein R is a C₁-C₉ saturated or unsaturated, substituted or unsubstituted, straight or branched alcohol or a C₁-C₉ saturated or unsaturated, substituted or unsubstituted, straight or branched amine. For example, R is selected from a saturated or unsaturated, substituted or unsubstituted C₁-C₉ alcohol, or a saturated or unsaturated, substituted or unsubstituted C₁-C₉ amine. In this example of the hydrophilic, reactive additive, the pyridine portion of the additive is the hydrophilic portion and the amine or alcohol is the reactive portion. It will be understood that any suitable salt may be used. For example, the salt may be derived from one of the acids, wherein the cation of the salt is selected from lithium, sodium, potassium, Groups HA, IB, IIB. IIIA and VIII metals, ammonium, C₂-C₁₂ alkyl ammonium, quaternary ammonium, and C₁₂-C₂₄ alkyl quaternary ammonium.

In some embodiments, the hydrophilic, reactive additive may have a structure as shown below:

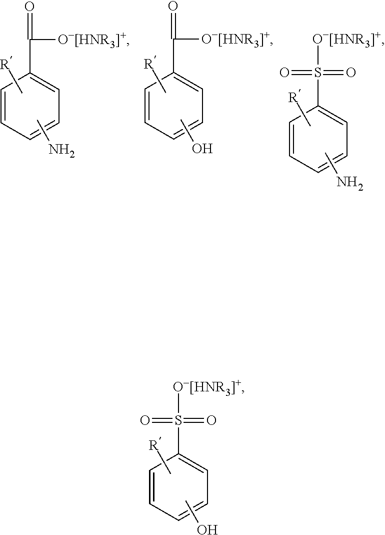

or combination thereof, wherein R is a C₁-C₉ saturated or unsaturated, substituted or unsubstituted, straight or branched alkyl and R′ is nothing or a C₁-C₉ saturated or unsaturated, substituted or unsubstituted, straight or branched alkyl. For example, each occurrence of R can be independently selected from a substituted or unsubstituted C₁-C₉ alkyl, a substituted or unsubstituted alkenyl, or a substituted or unsubstitutedC₂-C₉ alkynyl; and can be absent or selected from substituted or unsubstituted C₁-C₉ alkyl, a substituted or unsubstituted C₂-C₉ alken.yl, or a substituted or unsubstituted C₂-C₉ alkynyl. In this example of the hydrophilic, reactive additive, the reactive portion may be a hydroxy or amine group and the hydrophilic portion may be the carbonyl or sulfonyl portion.

Specific examples of suitable hydrophilic, reactive additives include, but are not limited to, o-aminobenzoic acid-triethylamine salt (o-aminobenzoic acid.-(Et)₃N), 4-(2-hydroxyethyl) morpholine, 2-(2-hydroxyethyl) pyridine, m-aminobenzoic acid-triethylamine salt, p-aminobenzoic acid-triethylamine salt, o-aminobenzenesulfonic acid-tiethylamine salt, m-aminobenzenesulfonic acid-triethylamine salt, p-aminobenzenesulfonic acid-triethylamine salt, o-aminotoluenesulfonic acid-triethylamine salt, m-aminotoluenesulfonic acid-triethylamine salt, p-aminotoluenesulfonic acid-triethylamine salt, o-hydroxybenzoic acid-triethylamine salt, m-hydroxybenzoic acid-tiethylamine salt, and p-hydroxybenzoic acid-triethylamine salt. For example, the hydrophilic, reactive additive may be o-aminobenzoic acid-triethylamine salt, 4-(2-hydroxyethyl) morpholine, or 2-(2-hydroxyethyl) pyridine.

The hydrophilic additive derived from a hydrophilic, reactive additive may be present in any suitable amount. For example, the hydrophilic additive or additives may be present in an amount sufficient to achieve an increase in the flux capacity, salt rejection capability, or both of a membrane versus the same membrane made in the absence of the hydrophilic additives. In some examples, the hydrophilic additive and the crosslinked polyamide can be present in a weight ratio of 0.01:500 or greater, such as 0.01:400 or greater, 0.01:300 or greater, 0.01:100 or greater, 0.01:50 or greater, 0.01:20 or greater. 0.01:10 or greater, 0.01:1 or greater, from 0.01:500 to 0.01:1, from 0.01:100 to 0.01:1, from 0.01:50 to 0.5:1, from 0.1:100 to 0.5:1, or from 0.1:10 to 0.2:1.

In some examples, the hydrophilic, reactive additive can be included in the solution comprising the polyamine or the acyl halide, before contacting the porous support. The concentration of the hydrophilic, reactive additive in the polyamine solution of polyfunctional acyl halide solution can be from 0.01 to 50.0% by weight, from 0.05 to 25.0% by weight, from 0.2 to 20.0% by weight, from 1.0 to 10,0% by weight, from 1.0 to 5.0% by weight, from 2.0 to 4.0% by weight, or from 2.8 to 3.0% by weight.

In some examples, the at least one hydrophilic additive is present in an amount sufficient so that the membrane exhibits a salt rejection capability of at least 95% when tested with a 2,000 ppm NaCl solution at 225 psi and a flux rate of at least 25 gfd. In another example, the at least one hydrophilic additive can be present in an amount sufficient so that the membrane exhibits a salt rejection capability of at least 96% when tested with a. 2000 ppm NaCl solution at 225 psi and a flux rate of at least 30 gfd. In yet other examples, the at least one hydrophilic additive can be present in an amount sufficient so that the membrane exhibits a salt rejection capability of at least 98% when tested with a 2000 ppm NaCl solution at 225 psi and a water flux rate of at least 34 gal/ft²/day (gfd) (1.39 m³/m²/day).

In some embodiments, methods of forming water permeable membranes are provided. The methods can comprise applying a solution of at least one aromatic or aromatic/aliphatic polyamine to a porous support and applying a polyfunctional acyl halide solution to a porous support such that a water permeable membrane is formed, wherein at least one hydrophilic, reactive additive is present in at least one of the solution of aromatic or aromatic/aliphatic polyamine and the polyfunctional acyl halide solution.

Additional Treatments and Components

It will be understood that any suitable additional treatments or membrane components may be used. For example, the water permeable membrane may be dried prior to storage and/or shipment. For example, the membrane may be dried at 60 to 100° C., for 5 to 20 minutes or at 85 to 95° C. for 10 to 15 minutes. See. R J. Petersen, “Composite Reverse Osmosis and Nanofiltration Membranes,” J. Membr. Sci., 83, 81 (1993), for examples of suitable drying conditions.

Drying water permeable membranes above 60° C. may result in a loss of water flux and/or salt rejection capabilities of the membrane. To ameliorate this problem, the membranes can be treated to incorporate a flux-enhancing additive therein by soaking the membrane in a flux-enhancing additive, by introducing the flux-enhancing compound into the membrane during interfacial polymerization, or by a combination of both methods. U.S. Pat. Nos. 5,658460; 6,368,507; and 6,464,873 describes suitable flux-enhancing additive, the disclosures of which are incorporated herein by reference.

Any suitable flux-enhancing additives may be used. For example, compounds containing hydroxyl-moieties and combinations of these compounds may be used. For example, compounds containing hydroxyl moieties include, but are not limited to, glycerol, ethylene glycol, diethylene glycol, triethylene glycol, tetraethylene glycol, polyethylene glycol, and polyvinylalcohol may be used.

Organic acid salts, combinations of organic acid salts, and combinations of hydroxyl containing compounds and organic acid salts may also be used as flux-enhancing additives. Specific examples of organic acid salts include, but are not limited to, camphorsulfonic acid-triethylamine salt, camphorsulfonic acid-N,N-dimethyl-3-aminopyridine salt, camphorsulfonic acid-sodium salt, camphorsulfonic acid-potassium salt, toluenesulfonic acid-triethylamine salt, toluenesulfonic acid-N,N-dimethyl-3-aminopyridine salt, toluene sulfonic acid-sodium salt, toluenesulfonic acid-potassium salt, benzenesulfonic acid-triethylamine salt, benzenesulfonic acid-N,N-dimethyl-3-aminopyridine salt, benzenesulfonic acid-sodium salt, benzenesulfonic acid-potassium salt, methanesulfonic acid-triethylainine salt, methanesulfonic acid-N,N-dimethyl-3-aminopyridine salt, and methanesulfonic acid-sodium salt, methanesulfonic acid-potassium salt, or mixtures thereof.

Flux-enhancing additives may be added by soaking the membranes in an aqueous solution of the additive. It will be understood that the flux-enhancing additive may have any suitable concentration in the solution. If the flux-enhancing additive is a hydroxyl-containing compound, the concentration of the compound in aqueous solution may be 1.0 to 20.0% by weight or 3.0 to 8.0% by weight, for example. If the flux-enhancing additive is an organic acid salt, the concentration of the acid salt in aqueous solution may be 1.0 to 20.0% by weight, 3.0 to 10.0% by weight, or 5.0 to 8.0% by weight, for example. Where the flux-enhancing compound is added during interfacial polymerization, a corresponding amount may be used.

The aqueous solution of flux-enhancing additive may further contain a surfactant for improved results. The particular surfactant employed is not critical. Non-limiting examples include sodium lauryl sulfate, sodium dodecylbenzene sulfonate, or sodium dodecylphenoxybenzene sulfonate. Mixtures of surfactants could also be employed. Any suitable amount of surfactant may be used. For example, the surfactant may be present in solution in an amount of 0.01 to 0.5% by weight or 0.25 to 0.35% by weight.

In some instances, the membrane may be soaked in a neutralization solution before soaking in the aqueous solution of flux-enhancing additive. Any suitable aqueous solutions neutralization solutions having any suitable concentration may be used. For example, aqueous solutions of sodium carbonate and/or sodium sulfate containing, for example, 0.2% by weight sodium carbonate and 3.3% by weight sodium sulfate, may be used.

In order to further enhance their water flux capacities, water permeable membranes made from interfacially polymerized polyamides can be heat treated by heating the membrane to any suitable temperature for any suitable amount of time. For example, the membranes may be heated at 50 to 180° C., 70 to 110° C., or 80 to 100° C. for 1 to 60 minutes, 5 to 30 minutes, or 12 to 16 minutes. See, R. J. Petersen, “Composite Reverse Osmosis and Nanofiltration Membranes,” J. Membr. Sci., 83, 81 (1993), for suitable heat treatment methods and conditions.

In some embodiments, the membrane formed can go through plasma treatment to further increase salt rejection. Plasma treatment, e.g., using oxygen, fluorine, methane or combinations thereof, can density the membrane surface and hence increase salt rejection. In some cases, due to the surface densification, water flux may reduce to some extent. However, the resultant membrane can still possess higher water flux than the membranes prepared not according to the present disclosure.

Membrane Types and Methods of Use

The water permeable membranes of the present disclosure may be used in any suitable manner. For example, the water permeable membranes may be reverse osmosis membranes. The water permeable membranes may be dialysis membranes. In other examples, the water permeable membranes may be pervaporation membranes.

In some embodiments, methods for desalinating water are provided. The methods comprise passing the water under pressure through a membrane in accordance with the present disclosure. In other embodiments, methods for dialysis are provided. The methods comprise contacting a membrane in accordance with the present disclosure with a solution containing solutes and allowing water to diffuse through the membrane, In yet other embodiments, methods for performing pervaporation are provided. In some embodiments the methods comprise contacting a membrane in accordance with the present disclosure with a liquid feed solution and allowing pervaporation to occur. In other embodiments the methods comprise contacting a membrane in accordance with the present disclosure with a feed solution and allowing pervaporation to occur with the permeate under vacuum.

The present disclosure will be better understood by reference to the following examples which are offered by way of illustration not limitation.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the disclosure. Unless indicated otherwise, parts and percentages are on a weight basis, temperature is in ° C. or is at ambient temperature, and pressure is at or near atmospheric.

### Examples of High-Flux Water Permeable Membranes

Abstract: Water permeable membranes and methods of forming water permeable membranes are provided, The water permeable membranes are comprised of a crosslinked polyamide containing at least one kind of nanoparticles and one hydrophilic additive derived from a bifunctional additive that is hydrophilic and reactive. Furthermore, in accordance with other embodiments of this disclosure, methods of forming water permeable membranes comprised of a crosslinked polyamide containing at least one kind of nanoparticles and one hydrophilic additive derived from a bifunctional additive that is hydrophilic and reactive are provided. Specifically, the water permeable membranes may comprise a membrane formed from a crosslinked aromatic or aromatic/aliphatic polyamide interfacially polymerized on a porous support. The presence of the at least one kind of nanoparticles and one hydrophilic additive improves the water flux and salt retention properties of the membrane in comparison to a membrane formed without the at least one kind of nanoparticles and/or one hydrophilic additive. In addition, the membrane formed can go through plasma treatment to further increase salt rejection.

Introduction: In the examples, the membranes synthesized are characterized in a laboratory reverse osmosis membrane unit under brackish water desalination conditions using a 2000 ppm NaCl solution in deionized water at 225 psi. The membrane unit is a closed-loop test system consisting of a polypropylene tank of 5 gal for water supply, a cartridge filter, a constant temperature bath, a high-pressure (up to 1000 psi) positive-displacement pump, a surge tank, a pressure gauge, a membrane cell, a pressure control needle valve, and a rotameter. For each membrane sample, both the water flux and salt rejection were obtained. The water flux was determined by weighing the permeate sample collected for a period of time. The salt rejection was determined from the measurements of the salinities of the permeate and feed samples using a conductivity/salinity meter, i.e.:

Salt Rejection=(Feed Salinity−Permeate Salinity)/Feed Salinity

The membranes synthesized can also be characterized in the laboratory reverse osmosis membrane unit under seawater conditions using a 3.28% NaCl solution in deionized water at 800 psi.

Comparative Example A: (Based on U.S. Pat. No. 4,277,344, not in accordance with the membranes of the present disclosure). Synthesis of the Membrane without the Hydrophilic Additive o-Aminobenzoic Acid-Triethylamine Salt in Amine Solution: A microporous polysulfone support with a surface pore size of 50 nm was soaked in isopropyl alcohol (IPA) for 2 hours. The support was then rinsed in deionized water 3 times for 10 minutes per rinse. The back side of the support was dried with a Kimwipe® paper and then taped on a glass plate. The support on a glass plate was put back to deionized. water for 10 seconds. After taking the support out of the deionized water, the excess water on the top surface of the support was removed and dried with a Kimwipe® paper gently.

The top surface of the support was then dipped in an amine solution containing 1.9 wt. % m-phenylenediamine (amine), 5 wt. % camphorsulfonic acid-triethylamine (flux-enhancing additive), and 0.2 wt. % sodium lauryl sulfate (surfactant) in IPA, for 10 seconds.

The support was then removed from the amine solution, and the excess amine solution on the top surface of the support was removed using a squeegee roller. The top surface of the support was then dried in air for 3.5 minutes.

The top surface of the support was then contacted with an acyl halide solution containing 0.08 wt.,?/) of trimesoyl chloride((acyl halide) in Isopar G® for 7 seconds to generate a membrane via interfacial polymerization. The resulting membrane was drained and dried at 80° C. for 4 minutes for hydrocarbon removal. Finally, the membrane was soaked in deionized water before testing for desalination capabilities.

Using the laboratory reverse osmosis membrane unit under brackish water desalination conditions, utilizing a feed solution containing 2000 ppm NaCl in deionized water at 225 psi and 25° C., the membrane produced exhibited a water flux of 21.6 gal/ft²/day (gfd) (0.880 m³/m²/day) and a salt rejection of 97.7%.

Comparative Example B (Based on U.S. Pat. No. 4,277,344, not in accordance with the membranes of the present disclosure) Synthesis of the Membrane without the Hydrophilic Additive o-Aminobenzoic Acid-Tdethylamine Salt in Aqueous Amine Solution: Comparative Example A was repeated except that water instead of IPA was used as the solvent for the amine solution. The membrane produced exhibited a water flux of 20.8 gfd (0.847 m³/m²/day) and a salt rejection of 98.6%.

Comparative Example C (Based on U.S. Pat. No. 8,196,754, not in accordance with the membranes of the present disclosure)—Synthesis of the Membrane Using 2.85% of o-Aminobenzoic Acid-Triethylamine Salt (Hydrophilic Additive) in Amine Solution: A microporous polysulfone support with a surface pore size of 50 nm was soaked in isopropyl alcohol (IPA) for 2 hours. The support was then rinsed in deionized water 3 times for 10 minutes per rinse. The back side of the support was dried with a Kimwipe® paper and then taped on a glass plate. The support on a glass plate was put back to deionized water for 10 seconds. After taking the support out of the deionized water, the excess water on the top surface of the support was removed and dried with a Kimwipe® paper gently.

The top surface of the support was then dipped in an amine solution containing 2.85 wt. % o-arninobenzoic acid-triethylamine (hydrophilic additive), 1.9 wt. % m-phenylenediamine (amine), 5 wt. % camphorsulfonic acid-triethylamine (flux-enhancing additive), and 0.2 wt. % sodium lauryl sulfate (surfactant) in IPA, for 10 seconds.

The support was then removed from the amine solution, and the excess amine solution on the top surface of the support was removed using a squeegee roller. The top surface of the support was then dried in air for 3.5 minutes.

The top surface of the support was then contacted with an acyl halide solution containing 0.08 wt. % of trimesoyl chloride (TMC acyl halide) in Isopar G® for 7 seconds to generate a membrane via interfacial polymerization. The resulting membrane was drained and dried at 80° C. for 4 minutes for hydrocarbon removal. Finally, the membrane was soaked in deionized water before testing for desalination capabilities.

Using the laboratory reverse osmosis membrane unit under brackish water desalination conditions, utilizing a teed solution containing 2000 ppm NaCl in deionized water at 225 psi and 25° C., the synthesized membrane showed a water flux of 36.7 gfd (1.50 m³/m²/day) and a salt rejection of 98.2%.

Comparative Example D (not in accordance with the membranes of the present disclosure)—Synthesis of the Membrane with 0.15 wt,% of Zeolite Y Nanoparticles of 150 nm but without the Hydrophilic Additive o-Aminobenzoic Acid-Triethylamine Salt in Amine Solution: A microporous polysulfone support with a surface pore size of 50 nm was soaked in an IPA/water (1:1 by weight) solution overnight and rinsed with deionized water for 5 min. Then, the support was soaked in deionized water for another 2 hours before it was taped onto a 5 inch×5 inch×0.2 inch glass plate. The excess water on the support surface was removed and dried at room temperature upon standing vertically. The polysulfone support together with the glass plate was then firmly clamped by a custom-fabricated 5 inch×5 inch×0.6 inch Teflon frame (inner opening: 4.2 inch×4.2 inch) with eight long tail clips.

Onto the top surface of the support clamped by the frame, an amine solution containing 0.15 wt. % of Zeolite Y nanoparticles of 150 nm, 2 wt. % m-phenylenediamine (amine), 5 wt. % camphorsulfonic acid-triethyl amine (flux-enhancing additive), and 0.2 wt. % sodium lauryl sulfate (surfactant) in water was poured. Homogeneous Zeolite dispersion in the amine solution could be obtained by uttrasonication for 1 h at room temperature immediately prior to use. The solution was allowed to soak on the support for 8 s. The frame was then removed and a squeegee roller was employed to gently drain off the excess amine solution on the top surface. Then, the support was dried upon standing vertically in the air for 2.5 min until no droplet could be seen on the membrane surface. The frame was clamped again, and a solution of 0.1 wt. % TMC in Isopar G® was slowly poured on the amine saturated support, After 8 s of interfacial polymerization reaction to form a membrane, the TMC solution was poured off, and the membrane was dried in the oven at 90° C. for 5 min for hydrocarbon removal. Finally, the membrane was separated from the glass plate and soaked in a neutralization solution containing 0.2 wt,% Na₂CO₃ and 3.3 wt. % Na₂SO₄ for 20 s. The membrane sample was then washed by dipping in deionized water at 47° C. four times each for 4 min.

During this membrane preparation process, the pouring of aqueous and organic phase solutions was gently carried out from the frame corner, and a customized air convection with the flow rate of 45 L/min was applied in an oven to remove the hydrocarbon evenly. It should be noted that these optimal membrane preparation conditions for TFC membranes were used according to our previous studies.

The membrane produced exhibited a water flux of 43.7 gfd (1.78 m³/m²/day) and a salt rejection of 98.8% under brackish water desalination conditions.

### Example 1

### Synthesis of the Membrane Using 0.15 wt. % of Zeolite Y

Nanoparticles of 150 nm and 2.85% of o-Aminobenzoic Acid-Triethylamine Salt (Hydrophilic Additive) in Amine Solution can be performed as follow: A microporous polysulfone support with a surface pore size of 50 nm is soaked in an WA/water (1:1 by weight) solution overnight and rinsed with deionized water for 5 min. The support is then soaked in deionized water for another 2 hours before it is taped onto a 5 inch×5 inch×0.2 inch glass plate. The excess water on the support surface is removed and dried at room temperature upon standing vertically. The polysulfone support together with the glass plate is then firmly clamped by a custom-fabricated 5 inch×5 inch×0.6 inch Teflon frame (inner opening: 4.2 inch×4.2 inch) with eight long tail clips.

Onto the top surface of the support clamped by the frame, an amine solution containing 0.15 wt. % of Zeolite Y nanoparticles of 150 nm, 2.85 wt. % o-aminobenzoic acid-triethylamine (hydrophilic additive), 2 wt. % m-phenylenediamine (amine), 5 wt. % camphorsulfonic acid-triethylamine (flux-enhancing additive), and 0.2 wt. % sodium laurel sulfate (surfactant) in water is poured. Homogeneous Zeolite dispersion in the amine solution is obtained by ultrasonication for 1 h at room temperature immediately prior to use. The solution is allowed to soak on the support for 8 s. The frame is then removed, and a squeegee roller is employed to gently drain off the excess amine solution on the top surface. The support is dried upon standing vertically in the air for 2.5 min until no droplet can be seen on the membrane surface. The frame is clamped again, and a solution of 0.1 wt. % TMC in Isopar G® is slowly poured on the amine saturated support. After 8 s of interfacial polymerization reaction to form a membrane, the TMC solution is poured off, and the membrane is dried in the oven at 90° C. for 5 min for hydrocarbon removal. Then, the membrane is separated from the glass plate and soaked in a neutralization solution containing 0.2 wt. % Na₂CO₃ and 3.3 wt. % Na₂SO₄ for 20 s. The membrane sample is then washed by dipping in deionized water at 47° C. four times each for 4 min. After rinsing, the post-treatment solution containing 5 wt. % glycerol, 6 wt. % CSA-TEA salt, and 0.3 wt. % SLS is used to soak the membrane for 2 min. Finally, an air knife is employed to remove the extra post-treatment solution on the membrane surface, followed by a. second-step drying in the oven at 90° C. for 10 min.

During this membrane preparation process, the pouring of aqueous and organic phase solutions is gently carried out from the frame corner, and a customized air convection with the flow rate of 45 L/min is applied in an oven to remove the hydrocarbon evenly and to do the second-step drying after the post-treatment.

Using the laboratory reverse osmosis membrane unit under brackish water desalination conditions, utilizing a feed solution containing 2000 ppm NaCl in deionized water at 225 psi and 25° C., the membrane of Example I can show a water flux of more than 50 gfd (2.04 m³/m²/day) and a salt rejection of 98.5%.

### Example 2

### Synthesis of the Membrane Using 0.15 wt. % of Zeolite Y

Nanoparticles of 40 nm and 2.85% of o-Aminobenzoic Acid-Triethylamine Salt (Hydrophilic Additive) in Amine Solution can be performed as follow: Example 1 is repeated except Zeolite Y nanoparticles of 40 nm are used. Without wishing to be bound by theory, our understanding is that smaller Zeolite Y nanoparticles, which are much smaller than the typical interfacially-polymerized membrane thickness of 0.2 microns (200 nm), can produce much less defects, thus the performance of the membrane can be expected to show a water flux of more than 50 gfd (2.04 m³/m²/day) and a salt rejection of 99% under brackish water desalination conditions.

### Example 3

### Synthesis of the Membrane Using 0.15 wt. % of Zeolite Y

Nanoparticles of 150 nm and 2.85% of o-Aminobenzoic Acid-Triethylamine Salt (Hydrophilic Additive) in Amine Solution Followed by Plasma. Treatment can be performed as follow: Example 1 is repeated. The membrane is then subjected to plasma treatment to densify the membrane surface for increasing salt rejection. The membrane can perform to exhibit a salt rejection of greater than 99% under brackish water desalination conditions, along with a water flux of 40 gfd (1.63 m³/m²/day) or higher.

Example 4

### Synthesis of the Membrane Using 0.15 wt. % of Zeolite Y

Nanoparticles of 40 nm and 2.85% of o-Aminobenzoic Acid-Triethylamine Salt (Hydrophilic Additive) in Amine Solution Followed by Plasma Treatment can be performed as follow: Example 1 is repeated except Zeolite Y nanoparticles of 40 nm are used. The membrane is them subjected to plasma treatment to densify the membrane surface for increasing salt rejection. The performance of the membrane can be expected to give a salt rejection of greater than 99% under brackish water desalination conditions, along with a water flux of 40 gfd (1.63 m³/m²/day) or higher.

### Embodiments

In some embodiments, water permeable membrane comprising a membrane formed from a crosslinked aromatic or aromatic/aliphatic polyamide interfacially polymerized on a porous support, wherein the membrane comprises at least one kind of nanoparticles selected from Zeolite Y and other nanoparticles, fumed silica, alumina, titania, zirconia, clay nanoparticles, carbon nanoparticles, metal-organic frameworks (MOFs), and zeolitic imidazole frameworks (ZIFs), and combinations of these, and one hydrophilic, reactive additive capable of reacting with the crosslinked polyamide selected from 4-(2-hydroxyethyl) morpholine and 2-(2-hydroxyethyl) pyridine, the salts thereof, and combinations of these; and wherein the hydrophilic additive is chemically bonded to the membrane structure during the interfacial polymerization that forms the interfacially polymerized membrane are disclosed.

The membrane of the preceding embodiment, wherein the at least one kind of nanoparticles and one hydrophilic additive are present in an amount sufficient so that the membrane exhibits a salt rejection capability of at least 98% when tested with a 2000 ppm NaCl solution at 225 psi and a flux rate of at least 34 gfd.

The membrane of any one of the preceding embodiments, wherein the polyamide is formed by reacting an essentially monomeric, aromatic or aromatic/aliphatic amine-reactive polyfunctional acyl halide with an amine solution comprising a monomeric polyamine.

The membrane of any one of the preceding embodiments, wherein the amine solution further comprises 0.05 to 1 percent by weight of the one kind of nanoparticles.

The membrane of any one of the preceding embodiments, wherein the amine solution further comprises 0.1 to 0.5 percent by weight of the one kind of nanoparticles.

The membrane of any one of the preceding embodiments, wherein the amine solution further comprises 0.2 to 20 percent by weight of the hydrophilic, reactive additive.

The membrane of any one of the preceding embodiments, wherein the amine solution further comprises 1 to 10 percent by weight of the hydrophilic, reactive additive

The membrane of any one of the preceding embodiments, wherein the amine solution further comprises 2 to 4 percent by weight of the hydrophilic, reactive additive.

In some embodiments, water permeable membrane comprising a membrane formed from a crosslinked aromatic or aromatic/aliphatic: polyamide interfacially polymerized on a porous support, wherein the membrane further comprises one kind of nanoparticles selected from Zeolite Y and other nanoparticles, fumed silica, alumina, titania, zirconia, clay nanoparticles, carbon nanoparticles, metal-organic frameworks (MOB), and zeolitic imidazole frameworks (ZIFs), and combinations of these, and a hydrophilic additive derived from a hydrophilic, reactive additive, are disclosed.

In some embodiments, water permeable membrane comprising a membrane formed from a crosslinked aromatic or aromatic/aliphatic polyimide interfacially polymerized on a porous support, wherein the membrane further comprises one kind of nanoparticles and a hydrophilic additive derived from a hydrophilic, reactive additive selected from:

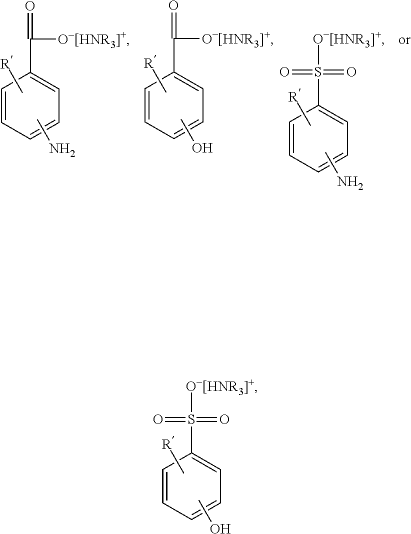

and combinations of these; wherein:

R is a C₁-C₉ saturated or unsaturated, substituted or unsubstituted, straight or branched alkyl; and

R′ is nothing or a C₁-C₉ saturated or unsaturated, substituted or unsubstituted, straight or branched alkyl, and wherein the hydrophilic, reactive additive is chemically bonded to the membrane structure during the interfacial polymerization that forms the interfacially polymerized membrane.

The membrane of any one of the preceding embodiments, wherein the hydrophilic additive derived from a hydrophilic, reactive additive is selected from o-aminobenzoic acid-triethylamine salt, m-aminobenzoic acid-triethylamine salt, p-aminobenzoic acid-triethylamine salt, o-aminobenzenesulfonic acid-ttiethylamine salt, m-aminobenzenesulfonic acid-triethylamine salt, p-aminobenezenesulfonic acid-triethylamine salt, o-aminotoluenesulfonic acid-triethvlamine salt, m-aminotoluenesulfonic acid-triethylamine salt, p-aminotoluenesulfonic acid-triethylamine salt, o-hydroxybenzoic acid-triethylamine salt, m-hydroxybenzoic acid-triethylamine salt, p-hydroxybenzoic acid-triethylamine salt, and mixtures thereof, are disclosed.

The membrane of any one of the preceding embodiments, wherein the membrane further comprises at least one additional hydrophilic additive derived from a hydrophilic, reactive additive selected from:

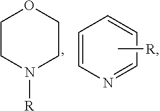

salts thereof, or combinations of these;

wherein R is a C₁-C₉ saturated or unsaturated, substituted or unsubstituted, straight or branched alcohol or a C₁-C₉ saturated or unsaturated, substituted or unsubstituted, straight or branched amine.

The membrane of any one of the preceding embodiments, wherein the at least one kind of nanoparticles and one hydrophilic additive derived from a hydrophilic, reactive additive are present in an amount sufficient so that the membrane exhibits a salt rejection capability of at least 98% when tested with a 2000 ppm NaCl solution at 225 psi and a flux rate of at least 34 gfd.

In some embodiments, water permeable membrane comprising one kind of nanoparticles and: a crosslinked polyamide containing one or more pendent reactive groups selected from the group consisting of amines, acyl halides, and mixtures there of residing on the surface of a porous substrate,

wherein the cross-linked polyamide is formed by interfacially polymerizing a multifunctional amine with a multifunctional acyl halide to an extent such that sufficient amine functional groups, acyl halide functional groups, or both remain unreacted to thereby comprise the one or more pendent reactive groups; and a hydrophilic, reactive additive selected from:

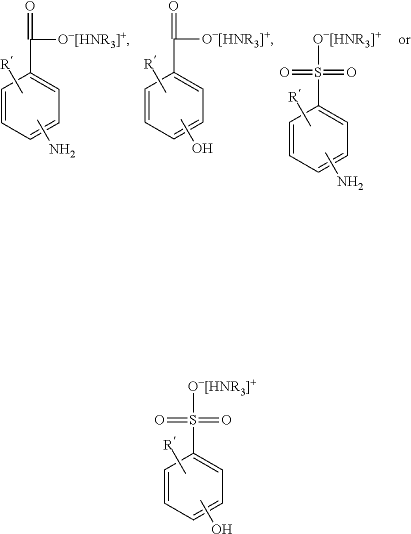

and combinations of these: wherein:

R is a C₁-C₉ saturated or unsaturated, substituted or unsubstituted, straight or branched alkyl; and R′ is nothing or a C₁-C₉ saturated or unsaturated, substituted or unsubstituted, straight or branched alkyl, wherein the additive is bound to the cross-linked polyamide by chemical attachment of the reactive portion of the additive to the one or more pendent reactive groups and is incorporated into the membrane structure during the interfacial polymerization that forms the interfacially polymerized membrane; and wherein the membrane exhibits improved water flux and improved salt retention properties compared to an otherwise identical membrane that does not contain any additive, are disclosed.

The membrane of any one of the preceding embodiments, wherein the one kind of nanoparticles and the additive are present in an amount sufficient so that the membrane exhibits a salt rejection capability of at least 98% when tested with a 2000 ppm NaCl solution at 225 psi and a flux rate of at least 34 gfd.

In some embodiments, method for forming a water permeable membrane, comprising: applying a solution of at least one aromatic or aromatic/aliphatic polyamine to a porous support; and applying a polyfunctional acyl halide solution to a porous support including pore surfaces such that a water permeable membrane is formed on the porous support comprising cross-linked aromatic or aromatic/'aliphatic polyamide that is interfacially polymerized on the pore surfaces, wherein at least one kind of nanoparticles selected from Zeolite Y and other nanoparticles, finned silica, alumina, titania, zirconia, clay nanoparticles, carbon nanoparticles, metal-organic frameworks (MOFs), and zeolitic imidazole frameworks (ZIFs), and combinations of these, and one hydrophilic, reactive additive selected from 4-(2-hydroxyethyl) morpholine and 2-(2-hydroxyethyl) pyridine, the salts thereof, and combinations of these, that chemically bonds to the membrane structure during the interfacial polymerization, is present in at least one of the solution of aromatic or aromatic/aliphatic polyamine and the polyfunctional acyl halide solution, are disclosed.

The method of any one of the preceding embodiments, further comprising soaking the water permeable membrane so formed in a flux enhancing solution.

The method of any one of the preceding embodiments, wherein the presence of the at least one kind of nanoparticles and one hydrophilic additive derived from a hydrophilic, reactive additive improves the flux and salt retention properties of the membrane in comparison to a membrane formed without the at least one hydrophilic, reactive additive.

In some embodiments, method for forming a water permeable membrane, comprising: applying a solution of at least one aromatic or aromatic/aliphatic polyamine to a porous support including pore surfaces; and applying a polyfunctional acyl halide solution to a porous support such that a water permeable membrane is formed on the porous support comprising crosslinked aromatic or aromatic/aliphatic polyamide that is interfacially polymerized on the pore surfaces, wherein at least one kind of nanoparticles and one hydrophilic, reactive additive are present in at least one of the solution of aromatic or aromatic/aliphatic polyamine and the polyfunctional acyl halide solution that the hydrophilic, reactive additive chemically bonds to the membrane structure during the interfacial polymerization, and wherein the at least one hydrophilic, reactive additive is selected from:

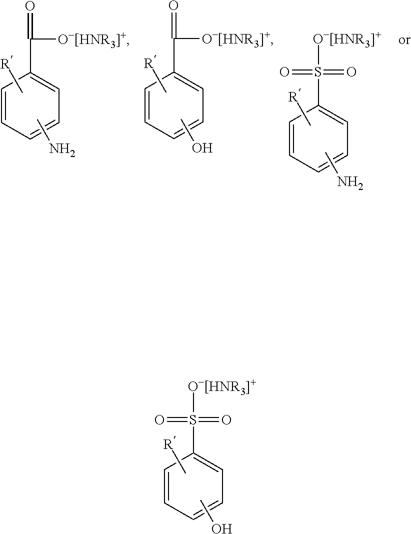

and combinations, wherein: R is a C₁-C₉ saturated or unsaturated, substituted or unsubstituted, straight or branched alkyl; and R′ is nothing or a C₁-C₉ saturated or unsaturated, substituted or unsubstituted, straight or branched alkyl are disclosed.

The method of any one of the preceding embodiments, further comprising soaking the water permeable membrane so formed in a flux enhancing solution.

The method of any one of the preceding embodiments, wherein the presence of the at least one kind of nanoparticles and one hydrophilic, reactive additive improves the flux and salt retention properties of the membrane in comparison to a membrane formed without the at least one kind of nanoparticles and one hydrophilic, reactive additive.

The method of any one of the preceding embodiments, further comprising subjecting the water soluble membrane so formed to plasma treatment to densify the membrane surface for increasing salt rejection.

In some embodiments, method for desalinating water comprising passing the water under pressure through a membrane according to any one of the preceding embodiments is disclosed.

In some embodiments, method for desalinating water comprising passing the water under pressure through a membrane according to any one of the preceding embodiments is disclosed.

In some embodiments, method for performing dialysis comprising contacting a membrane according to any one of the preceding embodiments with a solution containing solutes and allowing water to diffuse through the membrane is disclosed.

In some embodiments, method for performing pervaporation comprising contacting a membrane according to any one of the preceding embodiments with a feed solution and allowing pervaporation to occur is disclosed.

In some embodiments, method for performing pervaporation comprising contacting a membrane according to any one of the preceding embodiments with a liquid feed solution containing solutes and allowing pervaporation to occur is disclosed.

In some embodiments, method for performing pervaporation comprising contacting a membrane according to any one of the preceding embodiments with a liquid feed solution containing solutes and allowing pervaporation to occur with the permeate under vacuum is disclosed.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

1. A water permeable membrane comprising:
a porous support, and
a polyamide layer comprising a crosslinked polyamide on a surface of the porous support,
wherein the polyamide layer further comprises nanoparticles and a hydrophilic additive, and wherein the hydrophilic additive covalently bonds to the crosslinked polyamide.

2. A water permeable membrane comprising:
a porous support, and
a polyamide layer comprising a crosslinked polyamide interfacially polymerized on a surface of the porous support,
wherein the polyamide layer further comprises a hydrophilic additive and nanoparticles selected from the group consisting of zeolite Y nanoparticles, fumed silica nanoparticles, alumina nanoparticles, titania nanoparticles, zirconia nanoparticles, clay nanoparticles, carbon nanoparticles, metal-organic framework (MOF) nanoparticles, zeolitic imidazole framework (ZIF) nanoparticles, and combinations thereof.

3. A water permeable membrane comprising:
a porous support, and
a polyamide layer comprising a crosslinked polyamide on a surface of the porous support,
wherein the polyamide layer further comprises nanoparticles and a hydrophilic additive derived from a hydrophilic, reactive additive selected from: 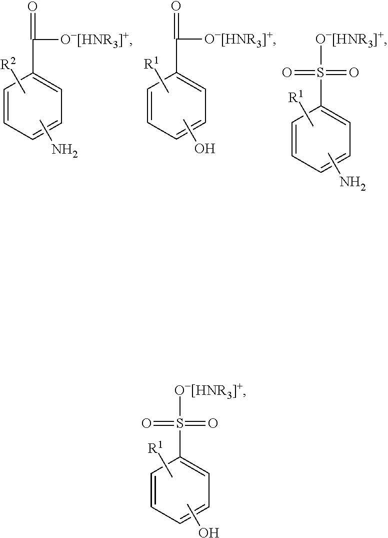
or a combination thereof,
wherein each occurrence of R is independently selected from a substituted or unsubstituted C₁-C₉ alkyl, a substituted or unsubstituted C₂-C₉ alkenyl, or a substituted or unsubstituted C₂-C₉ alkynyl; and
R′ is absent or selected from substituted or unsubstituted C₁-C₉ alkyl, a substituted or unsubstituted C₂-C₉ alkenyl, or a substituted or unsubstituted C₂-C₉ alkynyl.

4. A water permeable membrane comprising:
a) nanoparticles;
b) a crosslinked polyamide disposed on a surface of a porous substrate, wherein the crosslinked polyamide is formed by interfacially polymerizing a polyamine with a polyfunctional acyl halide in an amount, such that at least a portion of amine functional groups, acyl halide functional groups, or combinations thereof remain unreacted and form pendent reactive groups on the crosslinked polyamide; and
c) a hydrophilic additive reactive with the pendant reactive groups to covalently bind the hydrophilic additive and the crosslinked polyamide, wherein the hydrophilic, reactive additive is selected from: 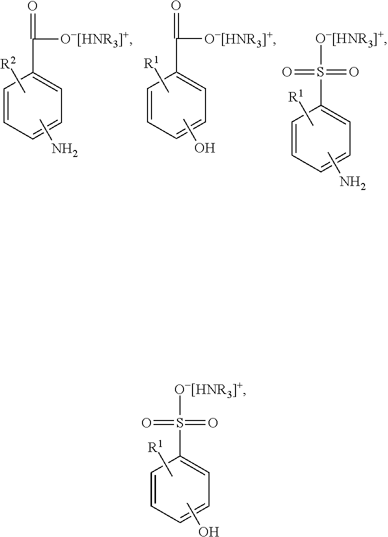
or a combination thereof,
wherein each occurrence of R is independently selected from a substituted or unsubstituted C₁-C₉ alkyl, a substituted or unsubstituted C₂-C₉ alkenyl, or a substituted or unsubstituted C₂-C₉ alkynyl; and
R′ is absent or selected from substituted or unsubstituted C₁-C₉ alkyl, a substituted or unsubstituted C₂-C₉ alkenyl, or a substituted or unsubstituted C₂-C₉ alkynyl; and
wherein the membrane exhibits improved water flux and salt retention properties compared to an otherwise identical membrane that does not contain the hydrophilic additive.

5. The water permeable membrane of claim 1, wherein the crosslinked polyamide is interfacially polymerized on the porous support.

6. The water permeable membrane of claim 1, wherein the crosslinked polyamide is derived from a polyamine monomer and a polyfunctional acyl halide.

7. The water permeable membrane of claim 6, wherein the polyamine monomer comprises an aromatic group or an aromatic-aliphatic group.

8. The water permeable membrane of claim 1, wherein the nanoparticles comprise zeolite Y, fumed silica, alumina, titania, zirconia, clay, carbon, metal-organic framework (MOF), zeolitic imidazole framework (ZIF), or a combination thereof.

9. The water permeable membrane of claim 1, wherein the nanoparticles and the crosslinked polyamide are present in a weight ratio of from 0.01:500 to 0.2:1, from 0.01:100 to 0.1:1, from 0.01:500 to 0.01:1, or from 0.01:100 to 0.01:1.

10. The water permeable membrane of claim 1, wherein the hydrophilic, reactive additive includes 4-(2-hydroxyethyl) morpholine, 2-(2-hydroxyethyl) pyridine, o-aminobenzoic acid-triethylamine, m-aminobenzoic acid-triethylamine, p-aminobenzoic acid-triethylamine, o-aminobenzenesulfonic acid-triethylamine, m-aminobenzenesulfonic acid-triethylamine, p-aminobenezenesulfonic acid-triethylamine, o-aminotoluenesulfonic acid-triethylamine, m-aminotoluenesulfonic acid-triethylamine, p-aminotoluenesulfonic acid-triethylamine, o-hydroxybenzoic acid-triethylamine, m-hydroxybenzoic acid-triethylamine, p-hydroxybenzoic acid-triethylamine, a salt thereof, or a combination thereof.

11. The water permeable membrane of claim 1, wherein the hydrophilic, reactive additive includes: 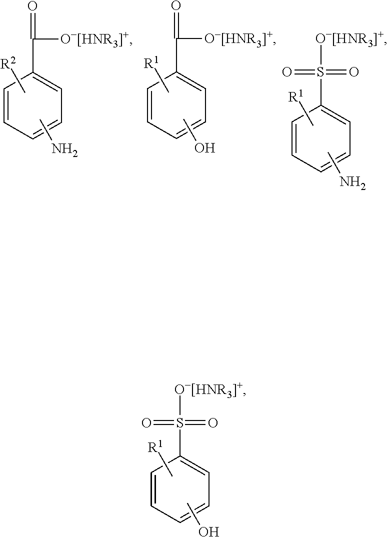
or a combination thereof,
wherein each occurrence of R is independently selected from a substituted or unsubstituted C₁-C₉ alkyl, a substituted or unsubstituted C₂-C₉ alkenyl, or a substituted or unsubstituted C₂-C₉ alkynyl; and
R′ is absent or selected from substituted or unsubstituted C₁-C₉ alkyl, a substituted or unsubstituted C₂-C₉ alkenyl, or a substituted or unsubstituted C₂-C₉ alkynyl.

12. The water permeable membrane of claim 1, further comprising an additional hydrophilic additive derived from a hydrophilic, reactive additive selected from: 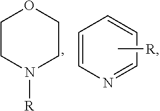
or a salt thereof, or a combination thereof;
wherein R is absent or selected from a saturated or unsaturated, substituted or unsubstituted C₁-C₉ alcohol, or a saturated or unsaturated, substituted or unsubstituted C₁-C₉ amine.

13. The water permeable membrane of claim 1, wherein the hydrophilic additive is included in the polyamide layer during interfacial polymerization of the crosslinked polyamide.

14. The water permeable membrane of claim 1, wherein the hydrophilic additive and the crosslinked polyamide are present in a weight ratio of from 0.1:100 to 0.5:1, or from 0.5:50 to 0.2:1, from 0.1:100 to 0.1:1, or from 0.5:50 to 0.5:1.

15. The water permeable membrane of claim 1, wherein the hydrophilic additive covalently bonds to the crosslinked polyamide.

16. The water permeable membrane of claim 1, wherein the water permeable membrane exhibits a salt rejection capability of at least 98%, when measured with a 2,000 ppm NaCl solution at 225 psi, and a flux rate of at least 34 gfd.

17. A method for forming a water permeable membrane, comprising:
a) applying a polyamine solution comprising a polyamine monomer to a porous support;
b) applying an acyl halide solution comprising a polyfunctional acyl halide to the porous support; and
c) allowing the polyamine monomer and the polyfunctional acyl halide to polymerize on
a pore surface of the porous support to form a crosslinked polyamide,
wherein nanoparticles and a hydrophilic, reactive additive are independently present in at least one of the polyamine solution or the acyl halide solution.

18-30. (canceled)

31. A method for desalinating water comprising passing the water under pressure through a membrane according to claim 1.

32. A method for performing dialysis comprising contacting a membrane according to claim 1 with a solution containing solutes and allowing water to diffuse through the membrane.

33. A method for performing pervaporation comprising contacting a membrane according to claim 1 with a feed solution and allowing pervaporation to occur.
